(19) United States
(12) Patent Application Publication
(10) Pub. No.: US 2025/0271665 A1
(43) Pub. Date: Aug. 28, 2025

(54) VEHICLE DISPLAY SYSTEM

(71) Applicant: Tae Woo KIM, Seongnam-si (KR)

(72) Inventor: Tae Woo KIM, Seongnam-si (KR)

(21) Appl. No.: 18/812,363

(22) Filed: Aug. 22, 2024

Related U.S. Application Data
(60) Provisional application No. 63/568,636, filed on Mar. 22, 2024.

(30) Foreign Application Priority Data
Feb. 22, 2024 (KR) 10-2024-0025472
May 3, 2024 (KR) 10-2024-0059449

(51) Int. Cl. G02B 27/01; B60K 35/231; G02B 1/00; G02B 5/08

(52) U.S. Cl. CPC G02B 27/0101; B60K 35/231; G02B 1/002; G02B 5/0816; B60K 2360/23; B60K 2360/25

(57) ABSTRACT

Provided is a vehicle display system including a projector configured to emit projection light to a display mirror configured to reflect the projection light and transmit first reflected light to an optical reflector, as second reflected light reflected on the optical reflector is incident, to display a virtual image that is visible to a user in a vehicle; and the optical reflector positioned in one region in the vehicle to reflect the first reflected light to the display mirror. A polarizing filter having a polarization axis in a first direction is coated on an external lens emitting the projection light. The display mirror is one region of a windshield, made of glass, a window, and a transparent flat plate, made of glass or acrylic, and a polarizing filter having a polarization axis in a second direction perpendicular to the first direction is coated on an inside of the display mirror.

### CROSS-REFERENCE TO RELATED APPLICATION

This application claims priority to and the benefit of Korean Patent Application No. 10-2024-0025472, filed Feb. 22, 2024, Korean Patent Application No. 10-2024-0059449, filed on May 3, 2024, and U.S. Patent Application No. 63/568,636 dated Mar. 22, 2024, the entire disclosures of which are incorporated herein by reference.

### BACKGROUND OF THE INVENTION

### 1. Field of the Invention

The present disclosure relates to a display system installed inside a vehicle, and more particularly to a technology for providing various display images using a windshield, etc. in a vehicle.

### 2. Description of the Related Art

Displays have been installed and provided in vehicles to assist the driver's driving or offer displays for entertainment.

In particular, as autonomous driving technology has been intensively studied recently, the use of displays for various purposes other than driving in vehicles has increased. For this reason, display screens installed in vehicles are gradually becoming larger.

While an increasingly enlarged display screen has the advantage of improving the user's image visibility, there are disadvantages in that the display screen occupies a very large area inside a vehicle, which reduces the driver's driving concentration or obstructs the airflow of a vehicle's air ventilation system.

In addition, HeadUpDisplays (HUDs) are also widely used to display essential information necessary for driving without lowering the driver's concentration in a vehicle. However, HUDs have a very small screen, making them unsuitable for continuous video viewing, having a very narrow viewing angle, and using a high-power, high-brightness light source to maintain visibility even during the day.

Meanwhile, optical modulation devices for changing the light transmission, reflection, and scattering characteristics, or for modulating the phase, amplitude, polarization, intensity, and path, are being utilized for various purposes. As such optical modulation devices, microelectromechanical system (MEMS) structures that utilize the mechanical micro-motion of light blocking and reflection are being studied. In particular, structures such as metagrating or metasurfaces that induce optical modulation by utilizing the surface plasmon resonance phenomenon for incident light have been studied in recent years.

### RELATED ART DOCUMENT

### Non-Patent Document

Metagratings: Beyond the Limits of Graded Metasurfaces for Wave Front Control, Younes Ra'di, Dimitrios L. Sounas, and Andrea Alu, Phys. Rev. Lett. 119, 067404-Published 10 Aug. 2017

### SUMMARY OF THE INVENTION

Therefore, the present disclosure has been made in view of the above problems, and it is an object of the present disclosure to provide a vehicle display system that occupies a minimum space in a vehicle and uses glass installed in the vehicle to create a wide screen.

In accordance with the present disclosure, the above and other objects can be accomplished by the provision of a vehicle display system.

The vehicle display system includes a projector configured to emit projection light toward an optical reflector; an optical reflector positioned in one region in a vehicle to reflect the projection light; and a display mirror configured to display a virtual image, which is visible to a user, in a vehicle as the light reflected on the optical reflector is incident.

In the projector, a polarizing filter having a polarization axis in a first direction is coated on an external lens emitting the projection light.

The display mirror is one region of a windshield, made of glass, a window, and a transparent flat plate, made of glass or acrylic, in the vehicle.

A polarizing filter having a polarization axis in a second direction perpendicular to the first direction is coated on an inside of the display mirror.

The projector is positioned in one region of an overhead console located at a top of a vehicle based on a driver, pillar A in the vehicle, pillar B in the vehicle, an armrest of a rear row of the vehicle, and a ceiling of the rear row of the vehicle.

The optical reflector is positioned in one region of a dashboard and ceiling in the vehicle and an inside of a door.

The display mirror is one region of the windshield.

The optical reflector includes a meta-surface on which a plurality of nanostructures are arranged and which diffracts and reflects the projection light according to a shape and arrangement form of each of the arranged nanostructures.

The nanostructures have a thickness thinner than a wavelength of the projection light.

An arrangement distance between the nanostructures is shorter than the wavelength of the projection light.

The optical reflector includes: a substrate; and a plurality of nanostructures arranged on the substrate and configured to function as a meta-surface.

The substrate includes a transparent film layer configured to transmit the projection light; a reflective layer positioned under the transparent film layer; and an adhesive layer positioned under the reflective layer.

The optical reflector further includes a phase synchronization part configured to apply voltage to each of the nanostructures in conjunction with a controller of the projector.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates the conceptual diagram of a vehicle display system according to one embodiment;

FIG. 2 illustrates the side view of an optical reflector according to an embodiment;

FIG. 3 illustrates the lamination drawing of a substrate of the optical reflector according to FIG. 2;

FIG. 4 illustrates the plan view of the optical reflector according to an embodiment;

FIG. 5 is a block diagram illustrating functional parts of a projector according to an embodiment;

FIG. 6 illustrates another installation example of the vehicle display system according to one embodiment.

FIG. 7 is a conceptual diagram for explaining the structure of an optical reflection-type small projector according to an embodiment.

### DETAILED DESCRIPTION OF THE INVENTION

Since the present disclosure may be applied with various modifications and may have various embodiments, exemplary embodiments and drawings of the present disclosure are intended to be explained and exemplified. However, these exemplary embodiments and drawings are not intended to limit the embodiments of the present disclosure to particular modes of practice, and all changes, equivalents, and substitutes that do not depart from the spirit and technical scope of the present disclosure should be understood as being encompassed in the present disclosure. Like reference numerals refer to like elements in describing each drawing.

The terms such as “first,” “second,” “A” and “B” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the teachings of the present disclosure. The term “and/or” includes any or all combinations of one or more of the associated listed items.

It should be understood that when an element is referred to as being “connected to” or “coupled to” another element, the element may be directly connected or coupled to the other element or intervening elements may be present. In contrast, when an element is referred to as being “directly connected to” or “directly coupled to” another element, there are no intervening elements present.

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure will be described in detail by explaining exemplary embodiments of the disclosure with reference to the attached drawings.

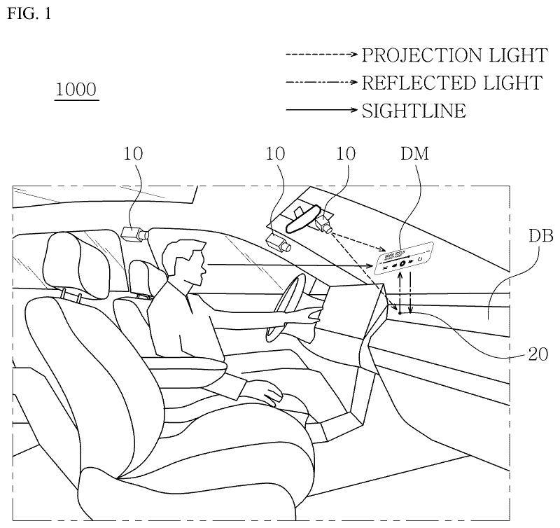

FIG. 1 illustrates the conceptual diagram of a vehicle display system according to one embodiment.

Referring to FIG. 1, a vehicle display system 100 according to one embodiment may include a projector 10 configured to emit projection light toward a region placed in front of a vehicle, an optical reflector 20 placed in the region to reflect the projection light emitted from the projector 10, and a display mirror DM configured to display a virtual image that can be seen by a user in the vehicle when reflected light reflected from the optical reflector 20 is incident.

In an embodiment, the projector 10 may be a Digital Light Processing (DLP)-type projector. The DLP-type projector can express the brightness of each pixel by controlling the time for which light is reflected through tilt transition corresponding to the on/off state of micro-mirrors using a Digital Mircromirror Device (DMD) chip corresponding to a semiconductor optical switch in which micro-actuated mirrors are integrated.

In another embodiment, the projector 10 may be a Laser Beam Scanning (LBS)-type projector. The LBS-type projector simultaneously scans the projection pixel brightness of laser used as a light source, projects it, and reflects it, so it provides relatively higher ANSI performance than the DLP-type projector that requires a large light source with high power consumption, and has the advantage of a high contrast ratio.

Here, in the projector 10, a polarizing filter having a polarization axis in a first direction may be coated on a part (e.g., an external lens) where projection light is emitted. The polarizing filter having the polarization axis in the first direction may be a film that allows light polarized in the first direction to pass through and blocks the remaining light. For example, the polarizing filter having the polarization axis in the first direction may transmit S-polarized light.

In an embodiment, the projector 10 may be positioned adjacent to a fixed installation portion of a rearview mirror in a vehicle. For example, the projector 10 may be positioned at the front or rear end of the fixed installation portion of the rearview mirror so as to face a dashboard.

In another embodiment, the projector 10 may be positioned so as to face the dashboard from an overhead console located at the top relative to a driver in the vehicle. For example, the overhead console may be interpreted as including the ceiling area, where a sun visor blocking the sunlight is installed, of the upper part of the vehicle; and the fixed installation portion of the rearview mirror.

In another embodiment, the projector 10 may be positioned on pillar A in the vehicle so as to face the dashboard.

In another embodiment, the projector 10 may be positioned on pillar B in the vehicle so as to face the dashboard. Specifically, the projector 10 may be positioned on an upper side of the pillar B in the vehicle.

That is, the projector 10 may be positioned at the rear of the vehicle with respect to the dashboard DB, and then emit projection light toward the optical reflector 20 (or the dashboard DB where the optical reflector 20 is positioned).

In addition, the projector 10 may emit projection light, instead of the optical reflector 20, toward the display mirror DM.

The optical reflector 20 may reflect the projection light, emitted from the projector 10, toward the display mirror DM. In still another embodiment, the optical reflector 20 may receive the reflected light from the display mirror DM and reflect the received reflected light to the display mirror DM. In particular, the optical reflector 20 may include a meta-surface where a plurality of nanostructures are arranged. The meta-surface diffracts and reflects projection light depending upon the shape and arrangement shape of each of the arranged nanostructures.

The optical reflector 20 may be positioned in one area of a dashboard and ceiling inside a vehicle and the inside of a door.

The meta-surface, which is a structure with a very small nano-unit size, is a two-dimensional form of metamaterial that is a general term for structures that induce light wave phenomena that are impossible with natural materials. Nanostructures of extremely small thickness are arranged, and depending on the shape and arrangement of the arranged nanostructures, the properties of light, such as amplitude, wavenumber, phase, and polarization, can be changed very rapidly.

The display mirror DM may be one region of a windshield, made of glass, a window, and a transparent flat plate, made of glass or acrylic, within a vehicle.

That is, the display mirror DM may not be an independent device placed in a vehicle, but may be one region of a windshield, made of glass, a window, and a transparent flat plate, made of glass or acrylic in the vehicle. For example, it may be one region of a windshield. That is, a virtual image can be recognized by a user through a windshield functioning as the display mirror DM by reflected light incident on one region of the windshield.

A polarizing filter having a polarization axis in a second direction may be coated on the inside of one region (in the inward direction of the vehicle) of the display mirror DM. The second direction may be perpendicular to the first direction, and the polarization filter having a polarization axis in the second direction may allow P-polarized light to pass through.

That is, since the polarizing filter having a polarization axis in the second direction perpendicular to the first direction is coated on the inside of the display mirror DM, a display image displayed through the display mirror DM from the outside of the vehicle may not be identified.

The display mirror DM may receive the reflected light from the optical reflector 20, and display the received reflected light to a user in the form of a virtual image.

In still another embodiment, the display mirror DM may receive the projection light from the projector 10, and reflect the received projection light to transmit it to the optical reflector 20 as reflected light. The display mirror DM is coated with a polarizing filter in a direction perpendicular to the polarizing filter coated on an external lens of the projector 10, so that the projection light may not pass through the display mirror DM and may be reflected as reflected light toward the optical reflector 20.

In addition, the polarizing filter coated on the inside of the display mirror DM may help to minimize the influence of sunlight incident from the outside to the inside of the vehicle, thereby providing a clear display image.

That is, according to the first example of the present disclosure, the projector 10 may emit projection light to the display mirror DM, the display mirror DM may reflect the projection light as reflected light to the optical reflector 20, and the optical reflector 20 may reflect the received reflected light to the display mirror DM. In this case, since the path of light travels longer, there is an advantage that a large screen can be displayed within a minimum space.

In addition, according to the second example of the present disclosure, the projector may emit projection light to the optical reflector 20, and the optical reflector 20 may reflect the projection light as reflected light toward the display mirror DM. In this case, although the light travel path is relatively shorter than in the above-described example, the relative positions of the projector 10, the optical reflector 20, and the display mirror DM are configured such that the reflected light is transmitted only from the optical reflector 20 to the display mirror DM, so that the convenience of construction is relatively high.

Hereinafter, a description is provided based on the first example that the optical reflector 20 receives projection light, but the case based on the second example that the optical reflector 20 receives reflected light (hereinafter referred to as the first reflected light) from the display mirror DM and transmits the reflected light (hereinafter referred to as the second reflected light) to the display mirror DM can also be applied.

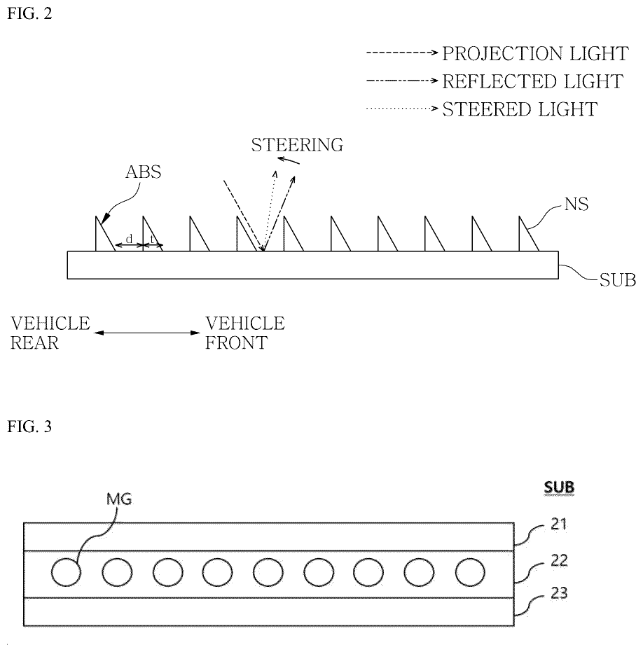

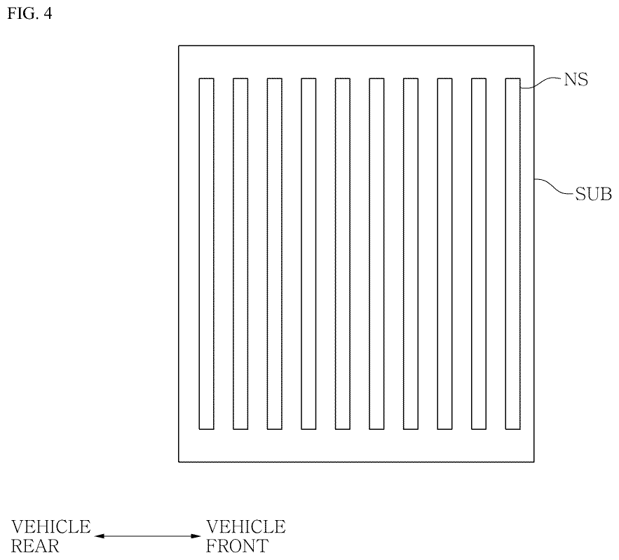

FIG. 2 illustrates the side view of an optical reflector according to an embodiment. FIG. 3 illustrates the lamination drawing of a substrate of the optical reflector according to FIG. 2. FIG. 4 illustrates the plan view of the optical reflector according to an embodiment.

In FIGS. 2 to 4, for convenience of explanation, the front direction of the vehicle is described as the direction in which the display mirror DM is located based on the optical reflector 20 when the optical reflector 20 is placed on the dashboard DB and the display mirror DM is used as one region of a windshield, but it should be interpreted that it can be changed depending upon the installation location described in this specification.

Referring to FIGS. 2 to 4, the optical reflector 20 may include a substrate SUB; and a plurality of nanostructures NSs arranged on the substrate SUB and configured to function as a meta-surface.

In an embodiment, the substrate SUB may include a transparent film layer 21 configured to transmit projection light, a reflective layer 22 disposed under the transparent film layer 21, and an adhesive layer 23 disposed under the reflective layer 22.

For example, the transparent film layer 21 may be an optically clear resin layer (OCR).

In the reflective layer 22, a plurality of transparent tubes or transparent balls based on silicon dioxide (SiO₂) may be positioned at predetermined distribution intervals (e.g., at predetermined left-right intervals, etc.) on the reflective layer 22. Here, a reflective coating layer may be arranged on the inner lower curvature regions (refers to the lower curved regions of the balls or tubes) of the transparent tubes or balls of the reflective layer 22.

For example, the reflective coating layer may be a mirror coating layer based on a metallic material, etc. Therefore, when the projection light passes through the transparent film layer 21 and reaches the reflective layer 22, it is reflected through the reflective coating layer, and the reflected light can be projected to the outside of the substrate SUB.

In an embodiment, the adhesive layer 23 may be formed using an optical acrylic adhesive composition.

A plurality of nanostructures NSs may be arranged along a predetermined array interval d in the longitudinal direction of the vehicle (a direction crossing between the front and rear of the vehicle).

Here, the plural nanostructures NSs may have a shape dimension of a sub-wavelength smaller than the wavelength of the projection light emitted from the projector 10. For example, the thickness t of the nanostructures NS may be smaller than the wavelength of projection light. In addition, an arrangement distance d between neighboring nanostructures NS among nanostructures NSs may be smaller than the wavelength of the projection light.

In particular, the arrangement distance of the nanostructures NS may be ½ (or ⅓) or less the wavelength of the projection light. By arranging the nanostructures NSs to be ½ or less the wavelength of the projection light, each of the nanostructures NS can function as a basic unit of the meta-structure that changes the properties of the light of the projection light.

The nanostructures NS may be configured to have a predetermined slope in a predetermined direction. For example, they may be configured to have the predetermined slope toward the windshield. Here, “have the predetermined slope toward the windshield” may mean that the slope is arranged parallel to the surface of the windshield or arranged to have a predetermined acute angle (within 45 degrees) based on the parallel arrangement.

In the nanostructures NS, the slope may be provided with an absorption layer ABS that absorbs external light. The absorbing layer may be surface-coated with a known optical coating material that absorbs light, or the absorbing layer material itself may be made of a conventional light-absorbing material.

In an embodiment, the nanostructures NS may be configured as rods extending in the width direction (i.e., left and right directions of a specific seat) of the vehicle, and may be shaped like a rod cut to have the slope. In this case, the thickness t of the nanostructure NS arranged in the center among the nanostructures NSs may be the thickest, and the thickness t of the nanostructure NS may gradually increase as it moves away from the center. For example, it can be configured to increase by a multiple of 1 or more every time the predetermined interval increases from the center.

In another embodiment, the nanostructures NS may be formed as cylinders extending in the direction of the vehicle width, and may have a shape that is cut from the cylinder to have the slope.

Although not shown in the drawings, the nanostructures NS are formed as cylinders, rod-shaped columns, triangular columns, etc., protruded to have a longitudinal direction perpendicular to the substrate SUB, and may have a shape cut to have the slope. In this case, the nanostructures NS may be configured such that the thickness t is thicker as they get closer to the center of the optical reflector 20, and the thickness t gradually increases as they get farther from the center. In addition, the spacing between the nanostructures NS may also be configured such that the spacing between the nanostructures NS becomes smaller as it approaches the center of the optical reflector 20 and increases as it moves away from the center of the optical reflector 20.

The nanostructures NS may be made of a dielectric material. For example, the nanostructures NS may be any one selected from single crystal silicon, polycrystalline silicon, amorphous Si, Si₃N₄, GaP, TiO₂, AlSb, AlAs, AlGaAs, AlGaInP, BP, and ZnGeP₂ having a refractive index greater than that of the substrate SUB.

In another embodiment, the nanostructures NS may be an alloy composed of one or more combinations of copper, aluminum, iron, cobalt, zinc, titanium, platinum, silver, gold, palladium, and iridium as conductive materials.

The absorption layer ABS can minimize the influence of reflected light by external light by absorbing external light coming through the windshield.

Meanwhile, the optical reflector 20 may further include a phase synchronization part (not shown) that applies voltage to each of the nanostructures NS in conjunction with a controller of the projector 10.

The phase synchronization part may induce an optical phase change of the nanostructures NS by applying a voltage that changes according to a cycle (e.g., a cycle identical to the image display cycle of the projector 10, a cycle obtained by multiplied the image display cycle by a predetermined proportional constant defined in advance, etc.) corresponding to the operation of the projector 10 to each of the nanostructures NSs, thereby allowing the nanostructures NS to operate in synchronization with the operation of the projector 10. The phase synchronization part may be electrically connected to a power line within the vehicle.

Specifically, the phase synchronization part may classify the plural nanostructures NSs into a plurality of groups, and match each of a plurality of pixels constituting a display screen output from the projector 10 to each of the classified groups. That is, one group corresponding to one pixel may be set. For example, phase synchronization operates such that, for each cycle corresponding to the image display cycle of the projector 10, a voltage (where the voltage corresponding to the color is predefined such that the nanostructures of the corresponding group have a specific reflection steering angle for the corresponding pixel) corresponding to the color of the pixel matched with the i-th group (where i is a natural number from 1 to n, n is the total number of groups) is applied to the i-th group among the plural groups.

When the phase synchronization part performs phase control of the nanostructures NS by applying voltage according to the display screen of the projector 10, the reflected light that is reflected by the projection light incident on the substrate SUB may be reflected with the emission angle steered according to the reflection steering angle. Here, the steered reflected light may be referred to as steered light.

In an embodiment, through the control of the nanostructures by the phase synchronization part, the incident angle of the projection light based on the surface normal vector (a line perpendicular to the surface of the substrate) of the substrate SUB and the emission angle of the steered reflected light, the steered light, may be defined according to Mathematical Equation 1 below:

$$sin ( {θ}_{sl} ) = sin ( {θ}_{ll} ) \pm \frac{ɛ}{T} \qquad [ Mathematical Equation 1 ]$$

In Mathematical Equation 1, ε is the wavelength of the projection light, T is a cycle corresponding to the image display cycle of the projector 10, θᵢₗ is the incident angle of the projection light, and θₛₗ is the emission angle of the steered light.

Here, the steered light controlled by the phase synchronization part may be diffracted light formed by diffracting the projection light more than once.

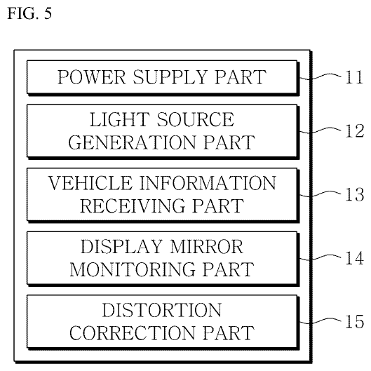

FIG. 5 is a block diagram illustrating functional parts of a projector according to an embodiment.

Referring to FIG. 5, the projector 10 may include a power supply part 11 electrically connected to a power source installed in a vehicle to provide driving power for the projector 10, a light source generation part 12 configured to generate a light source, which corresponds to display image data stored inside, by power supplied from the power supply part 11 and emit it as projection light, a vehicle information receiving part 13 configured to obtain vehicle information and multimedia information to be provided as a display screen by being linked with an ECU, an infotainment system, etc. in the vehicle, a display mirror monitoring part 14 configured to monitor the display screen displayed on the display mirror DM, and a distortion correction part 15 configured to generate distortion correction information according to the monitored display screen.

The vehicle information may be speed, tire pressure, internal temperature, engine RPM, etc., which are essential for vehicle control within the vehicle.

The multimedia information may refer to radio information, navigation information, etc. provided through an infotainment system within a vehicle.

The light source generated by the light source generation part 12 may be a laser light source.

The vehicle information receiving part 13 may obtain vehicle information and multimedia information by communicating with the vehicle via Bluetooth communication, Ethernet communication, CAN communication, etc.

The display mirror monitoring part 14 may be a camera positioned to capture a display screen within the vehicle, and it may be desirable that the camera is positioned as close to the driver's line of sight as possible.

In addition, the display mirror monitoring part 14 may be a camera positioned to capture not only the display screen but also the shape of the optical reflector 20 within the vehicle. Through this, the display mirror monitoring part 14 may obtain the curvature or shape of the optical reflector 20.

The distortion correction part 15 may generate distortion correction information through the in-vehicle display screen acquired by the display mirror monitoring part 14. For example, the position and shape of the display screen in the vehicle may be compared with a predefined reference position and reference shape (such as a rectangle) to obtain a difference value, and distortion correction information may be generated to offset the obtained difference value. For example, the distortion correction information may be data for adjusting the position and shape of the display image data in a direction that offsets the difference value.

The distortion correction part 15 may obtain a difference value by comparing the curvature or shape of the optical reflector 20 with a predefined reference curvature or reference shape, and generate auxiliary distortion correction information to offset the obtained difference value. The auxiliary distortion correction information may be information for correcting pixel values at specific locations constituting the display image data so as to correct the difference in optical reflection caused by differences in the curvature or shape of the optical reflector 20 (i.e., in the case of a dashboard, the curvature of the dashboard may be different for each vehicle).

The light source generation part 12 may correct the display image data using distortion correction information and/or auxiliary distortion correction information, and generate a light source based on the corrected display image data to emit projection light.

That is, since the display image data is corrected in real-time in consideration of the visibility and image distortion of a virtual image according to the installation location and curvature of the light source reflector 20 according to the present disclosure, the curvature and material of the windshield, etc. in real-time, the image can be corrected in real-time to provide a clear and accurate display screen.

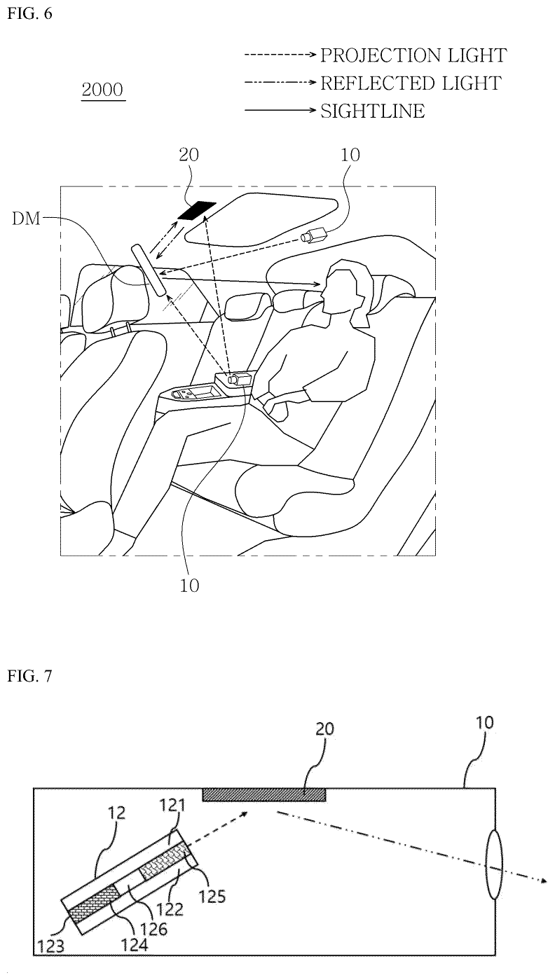

FIG. 6 illustrates another installation example of the vehicle display system according to one embodiment.

Referring to FIG. 6, a vehicle display system 2000 provided in the rear row (row after the first row) of a vehicle is described.

The vehicle display system 2000 provided in the rear row (row after the first row) of a vehicle according to FIG. 6 may include a projector 10 configured to emit projection light, an optical reflector 20 positioned in one region of the vehicle to reflect the projection light emitted from the projector 10, and a display mirror DM configured to display a virtual image that is visible to a user in the vehicle as the reflected light reflected on the optical reflector 20 is incident. In the vehicle display system 2000 according to another installation example, the projector 10 may be disposed on the ceiling of the vehicle's rear row (2nd or 3rd row), the C pillar of the vehicle, an armrest, etc., and may emit projection light to the optical reflector 20 or the display mirror DM.

As in the second example described above with reference to FIG. 1, the vehicle display system 2000 may include a projector 10 configured to emit projection light to a display mirror DM, a display mirror DM configured to reflect projection light and transmit the first reflected light to an optical reflector 20, and to display a virtual image that is visible to a user in a vehicle as the second reflected light reflected on the optical reflector 20 is incident, and an optical reflector 20 arranged in one region within the vehicle to reflect the first reflected light to the display mirror DM.

The optical reflector 20 may be positioned in one region of the ceiling of the rear row (two or more rows) of the vehicle.

The display mirror DM may be arranged in one region of a vehicle seat and may be made of a transparent flat material such as a glass material or an acrylic material. That is, in the embodiment according to FIG. 1, a glass material already existing in a vehicle is used as the display mirror DM, but in the embodiment according to FIG. 6, a separate transparent flat material may be constructed as the display mirror DM. However, it is not necessarily limited to this, and the door glass installed on the left or right side of the rear row of the vehicle may be utilized as the display mirror DM.

The region of the vehicle seat may mean one region of the rear of the seat located in the front row (right in front of the rear row) of the rear row of the vehicle, and, preferably, is arranged close to the eye level of a user.

The display mirror DM may be installed to be inclined at a predetermined angle toward a user seated in the rear row (e.g., such that the upper edge of the display mirror DM is inclined toward the user) such that it is easy to receive the first reflected light from the optical reflector and receive the second reflected light from the optical reflector 20.

FIG. 7 is a conceptual diagram for explaining the structure of an optical reflection-type small projector according to an embodiment.

A projector 10 according to another embodiment of the present disclosure may be an optical reflection-type small projector with an optical reflector 20 built inside.

Specifically, referring to FIG. 7, the projector 10 according to another embodiment may be configured such that the above-mentioned optical reflector 20 is built thereinside, and projection light emitted from a light source generation part 12 is transmitted to the optical reflector 20 in the projector 10.

In this embodiment, the optical reflector 20 may be named as a metalens, and the projector 10 may be referred to as a metalens optical system-based projector 10. The metalens optical system-based projector 10 may be miniaturized by including a metalens thereinside and may project a large image and perform optical system miniaturization.

In the embodiment according to FIG. 7, the optical reflector 20 may be positioned in one region of one side inside the projector 10. For example, the optical reflector 20 may be positioned in one region of the upper side inside the projector 10.

In this case, the light source generation part 12 is configured to emit projection light to the optical reflector 20 positioned in one region of one side inside the projector 10.

The light source generation part 12 may include a cavity region 123 forming laser cavity and an upper clad layer 121 and lower clad layer 122 respectively arranged above and below the cavity region 123 and spaced apart from each other.

The cavity region 123 may generate light having a predetermined wavelength band when electrons and holes are injected through the electrode layer. For example, the cavity region 123 may be a group III-V compound semiconductor, a quantum dot based on the corresponding group III-V chemical semiconductor, etc.

Although an electrode layer is not shown in the drawings, it is composed of a first electrode layer and second electrode layer, which are respectively arranged on the upper side of the upper clad layer 121 and the lower side of the lower clad layer 122, for current injection into the cavity region 123. So current injection into the cavity region 123 can be performed through a voltage applied between the first electrode layer and the second electrode layer.

Meanwhile, the cavity region 123 may include a first reflection region 123 and second reflection region 125 spaced apart from each other with a central cavity 126 as the center, in a direction (i.e., the emission direction of projection light in FIG. 7) crossing the cavity region 123 between the upper clad layer 121 and the lower clad layer 122.

On the upper and lower surfaces of the first reflection region 123 and second reflection region 125, the plural nanostructures NSs described above may be arranged according to the predetermined array interval and thickness described above, etc., and are configured to function as meta-surfaces in the same manner, but have a predetermined reflectivity.

For example, the first reflection region 123 and the second reflection region 125 may be configured to have the same reflectivity. More preferably, the first reflection region 123 may be configured to have a reflectivity higher than a predetermined reference value, and the second reflection region 125 may be configured to have a reflectivity lower than that of the first reflection region 123.

In an embodiment, the light source generation part 12 may be a laser diode.

The optical reflector 20 reflects the projection light emitted from the light source generation part 12 and transmits the reflected light to the outside through the external lens, and the arrangement direction of the projector 10 may be adjusted such that the reflected light reaches the display mirror DM.

In the case of the projector 10 according to FIG. 7, since the optical reflector 20 is placed inside the projector 10, the installation difficulty can be reduced, and a sufficiently large, high-definition screen can be created inside the projector 10 through the optical reflector 20.

As apparent above, since a miniaturized projector is used when using a vehicle display system according to the present disclosure, the area occupied by a display system within a vehicle can be minimized.

In addition, since it is possible to enlarge a screen and provide maximum clarity by using an optical reflector with a minimized area based on a meta-structure, there are advantages in that it is possible to provide a much larger screen than existing HUDs and it can be used for entertainment purposes in addition to essential driving information.

Further, by using polarization filters and optical patterns, it is possible to provide a display screen with a focused field of view by blocking the possibility of external visibility other than that of an intended user.

The methods according to the embodiments of the present disclosure may be implemented in the form of a program command that can be executed through various computer means and recorded in a computer-readable medium. The computer-readable medium can store program commands, data files, data structures or combinations thereof. The program commands recorded in the medium may be specially designed and configured for the present disclosure or be known to those skilled in the field of computer software.

Examples of a computer-readable recording medium may include hardware devices such as ROMs, RAMs and flash memories, which are specially configured to store and execute program commands. Examples of the program commands may include machine language code created by a compiler and high-level language code executable by a computer using an interpreter and the like. The hardware devices described above may be configured to operate as at least one software module to perform the operations of the disclosure, and vice versa.

In addition, the above-described method or apparatus may be implemented by combining all or part of constructions or functions thereof, or the constructions or functions may be separately implemented.

Although the present disclosure has been described above with reference to the embodiments of the present disclosure, those skilled in the art may variously modify and change the present disclosure without departing from the spirit and scope of the present disclosure as set forth in the claims below.

### DESCRIPTION OF SYMBOLS

10: projector
11: power supply part
12: light source generation part
13: vehicle information receiving part
14: display mirror monitoring part
15: distortion correction part
20: optical reflector
21: transparent film layer
22: reflective layer
23: adhesive layer
DM: display mirror

What is claimed is:

1. A vehicle display system, comprising:
a projector configured to emit projection light toward an optical reflector;
an optical reflector positioned in one region in a vehicle to reflect the projection light; and
a display mirror configured to display a virtual image, which is visible to a user, in a vehicle as reflected light reflected on the optical reflector is incident,
wherein, a polarizing filter having a polarization axis in a first direction is coated on an external lens of the projector,
the display mirror is one region of a windshield, made of glass, a window, and a transparent flat plate, made of glass or acrylic, in the vehicle, and
a polarizing filter having a polarization axis in a second direction perpendicular to the first direction is coated on an inside of the display mirror.

2. The vehicle display system according to claim 1, wherein the projector is positioned in one region of an overhead console located at a top of a vehicle based on a driver, pillar A in the vehicle, pillar B in the vehicle, an armrest of a rear row of the vehicle, and a ceiling of the rear row of the vehicle,
the optical reflector is positioned in one region of a dashboard and ceiling in the vehicle and an inside of a door, and
the display mirror is one region of the windshield.

3. The vehicle display system according to claim 1, wherein the optical reflector comprises a meta-surface on which a plurality of nanostructures are arranged and which diffracts and reflects the projection light according to a shape and arrangement form of each of the plurality of nanostructures,
the plurality of nanostructures have a thickness thinner than a wavelength of the projection light, and
an arrangement distance between the plurality of nanostructures is shorter than the wavelength of the projection light.

4. The vehicle display system according to claim 3, wherein the optical reflector comprises:
a substrate; and
the plurality of nanostructures arranged on the substrate and configured to function as a meta-surface,
wherein the substrate comprises:
a transparent film layer configured to transmit the projection light;
a reflective layer positioned under the transparent film layer; and
an adhesive layer positioned under the reflective layer.

5. A vehicle display system, comprising:
a projector configured to emit projection light to a display mirror;
the display mirror configured to reflect the projection light and transmit first reflected light to an optical reflector, and, as second reflected light reflected on the optical reflector is incident, to display a virtual image that is visible to a user in a vehicle; and
the optical reflector positioned in one region in the vehicle to reflect the first reflected light to the display mirror,
wherein, a polarizing filter having a polarization axis in a first direction is coated on an external lens of the projector,
the display mirror is one region of a windshield, made of glass, a window, and a transparent flat plate, made of glass or acrylic, in the vehicle, and
a polarizing filter having a polarization axis in a second direction perpendicular to the first direction is coated on an inside of the display mirror.
